(19) United States
(12) Patent Application Publication
(10) Pub. No.: US 2023/0316841 A1
(43) Pub. Date: Oct. 5, 2023

(54) DYNAMIC VOTING EXCHANGE PLATFORM

(71) Applicant: Shareholder Vote Exchange, Inc., San Jose, CA (US)

(72) Inventor: Preston Ben Yadegar, San Jose, CA (US)

(21) Appl. No.: 18/130,347

(22) Filed: Apr. 3, 2023

Related U.S. Application Data
(60) Provisional application No. 63/326,793, filed on Apr. 1, 2022.

(51) Int. Cl. G07C 13/00; G06Q 40/04

(52) U.S. Cl. CPC G07C 13/00; G06Q 40/04

(57) ABSTRACT

Systems and methods describe providing a dynamic voting exchange platform for buying, selling, and trading shareholder voting rights as voting assets. In one embodiment, the system maintains a voting exchange platform. The system receives a request from a user to issue one or more voting assets based on voting rights the user is entitled to act upon, the request including record information corresponding to the voting rights. The system then issues voting assets corresponding to the voting rights; receives a trading request corresponding to at least a subset of the issued voting assets, the trading request representing a purchase request or a sale request; matches the trading request with a complementary purchase request or sale request; and processes the matched requests by exchanging assets for value between a first account associated with a buyer and a second account associated with a seller.

### CROSS REFERENCE TO RELATED APPLICATIONS

This application claims the benefit of U.S. Provisional Patent Application No. 63/326,793, filed on Apr. 1, 2022, which is hereby incorporated by reference in its entirety.

### FIELD OF INVENTION

The present invention relates generally to corporate voting, and more particularly, to systems and methods for providing a dynamic voting exchange platform for buying, selling, and trading shareholder voting rights as voting assets.

### SUMMARY

The appended claims may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3A is a diagram illustrating one example embodiment of a seller workflow, in accordance with some embodiments.

FIG. 3B is a diagram illustrating one example embodiment of a buyer workflow, in accordance with some embodiments.

FIG. 4A is a diagram illustrating one example embodiment of an account overview page in a voting exchange platform, in accordance with some embodiments.

FIG. 4B is a diagram illustrating one example embodiment of an account holdings page in a voting exchange platform, in accordance with some embodiments.

FIG. 4C is a diagram illustrating one example embodiment of an account balances page in a voting exchange platform, in accordance with some embodiments.

FIG. 4D is a diagram illustrating one example embodiment of an account activity page in a voting exchange platform, in accordance with some embodiments.

FIG. 5A is a diagram illustrating one example embodiment of record information associated with shareholder voting rights, in accordance with some embodiments.

FIG. 5B is a diagram illustrating one example embodiment of requesting issuance of voting assets in a voting exchange platform, in accordance with some embodiments.

FIG. 5C is a diagram illustrating one example embodiment of an issuance request being submitted in a voting exchange platform, in accordance with some embodiments.

FIG. 5D is a diagram illustrating one example embodiment of an issuance request being confirmed in a voting exchange platform, in accordance with some embodiments.

FIG. 5E is a diagram illustrating one example embodiment of an activity page being updated with newly issued voting assets in a voting exchange platform, in accordance with some embodiments.

FIG. 6A is a diagram illustrating one example embodiment of a trading page in a voting exchange platform, in accordance with some embodiments.

FIG. 6B is a diagram illustrating one example embodiment of a sell order entry being submitted in a voting exchange platform, in accordance with some embodiments.

FIG. 6C is a diagram illustrating one example embodiment of a sell order entry being confirmed in a voting exchange platform, in accordance with some embodiments.

FIG. 6D is a diagram illustrating one example embodiment of a sell order book displaying a new sell order entry in a voting exchange platform, in accordance with some embodiments.

FIG. 7A is a diagram illustrating one example embodiment of a buy order entry being submitted in a voting exchange platform, in accordance with some embodiments.

FIG. 7B is a diagram illustrating one example embodiment of a buy order entry being confirmed in a voting exchange platform, in accordance with some embodiments.

FIG. 8A is a diagram illustrating one example embodiment of an active meeting voting page in a voting exchange platform, in accordance with some embodiments.

FIG. 8B is a diagram illustrating one example embodiment of a voting history page in a voting exchange platform, in accordance with some embodiments.

FIG. 9 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Corporations regularly hold annual and special corporate meetings in which shareholders and other authorized parties can vote on key issues facing the company. In these meetings, shareholders come together to decide important matters such as, e.g., selecting the board of directors, approving executive compensation packages, and amending company bylaws. Today, shareholders have multiple options regarding how they want to submit their votes, whether online, in person, by mail, or over the phone.

However, many shareholders feel that they have not done the proper research to vote responsibly, and many simply lack the time or motivation to vote in corporate meetings, a phenomenon known as “shareholder apathy”. Shareholders in such circumstances often take advantage of a popular method called “proxy voting”, whereby they can appoint someone else (i.e., a proxy) to vote on their behalf. In various embodiments, a proxy may be a single individual or a group of persons, and a proxy assignment can be revocable or irrevocable. In some embodiments, a proxy may also have the right to substitution (i.e., to be able to reappoint another person as their substitute proxy). Such proxy votes can be based on the shareholder's instructions, the appointed proxy's discretion, or some combination thereof (e.g., allowing the shareholder to vote on some voting proposals and assigning the proxy the right to vote on the remainder).

Appointing a proxy can allow shareholders to temporarily delegate voting authority to others who might be more familiar with or interested in voting. For instance, companies often issue their own proxy forms or voting instruction forms with a section for shareholders to appoint at least one of the company's directors to act as their proxyholder. In such cases, a company director acting as proxy holder will usually vote in line with management's overall voting recommendations. Appointing a proxy holder can be a convenient tool for shareholders who trust others with their voting rights and do not want to see their votes go to waste. However, industry estimates show that nearly 70% of all votes held by retail investors are not submitted each year, resulting in a significant waste of resources and lack of accountability.

Furthermore, prospective buyers of voting assets may utilize the platform to acquire additional voting rights. Such voting rights may be useful for shareholders who own classes of stock with limited voting rights, as in the case of preferred stock, dual-class share structures, tenure-voting (also known as “time-phased voting”), or other corporate provisions. Shareholders of common stock with equal voting rights, in companies with only a single class of stock, may also benefit from acquiring voting rights, if they seek to effect corporate change. Similarly, stakeholders who technically bear no voting rights as non-shareholders of a corporation may be interested in acquiring voting rights to influence corporate affairs. Parties may seek the advantage of acquiring voting rights, rather than acquiring shares bearing voting rights, for voting rights may be relatively inexpensive and capital-efficient.

Thus, there is a need in the field of shareholder voting to create a new and useful system and method for providing a dynamic voting exchange platform for the buying, selling, and trading of voting assets corresponding to shareholder voting rights. The source of the problem, as discovered by the inventors, is a lack of an exchange for trading voting rights, including the ability for shareholders to earn income by selling their votes, either by themselves or through proxies. This would allow for the issuance of voting assets out of shareholder voting rights, and these assets can then be traded via an exchange on the platform or exercised on the platform itself. Rather than abstaining altogether, focused investors would be able to make great use of selling their votes and can reinvest the proceeds to increase their long-term portfolio returns.

In one embodiment, the system maintains a voting exchange platform. The system receives a request from a user to issue one or more voting assets based on voting rights the user is entitled to act upon, the request including record information corresponding to the voting rights. The system then issues voting assets corresponding to the voting rights; receives a trading request corresponding to at least a subset of the issued voting assets, the trading request representing a purchase request or a sale request; matches the trading request with a complementary purchase request or sale request; and processes the matched requests by exchanging assets for value between a first account associated with a buyer and a second account associated with a seller.

In some embodiments, various features of the voting exchange platform may be implemented using blockchain, crypto-currency, and smart contract technologies. A blockchain is a list of data blocks linked together through the use of cryptographic functions. A blockchain begins with a genesis block, and all subsequent blocks contain cryptographic hashes of the prior block and a batch of new transactions. This approach secures the integrity of transaction records on the blockchain with respect to the complexity of the hash function in use. Private cryptographic keys may be recorded on the blockchain and used to access voting cryptocurrencies being transacted on the blockchain. The term “voting crypto-currency” may refer to a crypto-currency implementation of a voting asset (i.e., a crypto-currency that is backed at least by the voting rights of a shareholder on record pursuant to a specific corporate meeting). Virtual wallets can be used to store private and public keys to facilitate blockchain transactions. Smart contracts are self-executing programs that are stored on the blockchain which run automatically when pre-specified conditions are satisfied.

Further areas of applicability of the present disclosure will become apparent from the remainder of the detailed description, the claims, and the drawings. The detailed description and specific examples are intended for illustration only and are not intended to limit the scope of the disclosure.

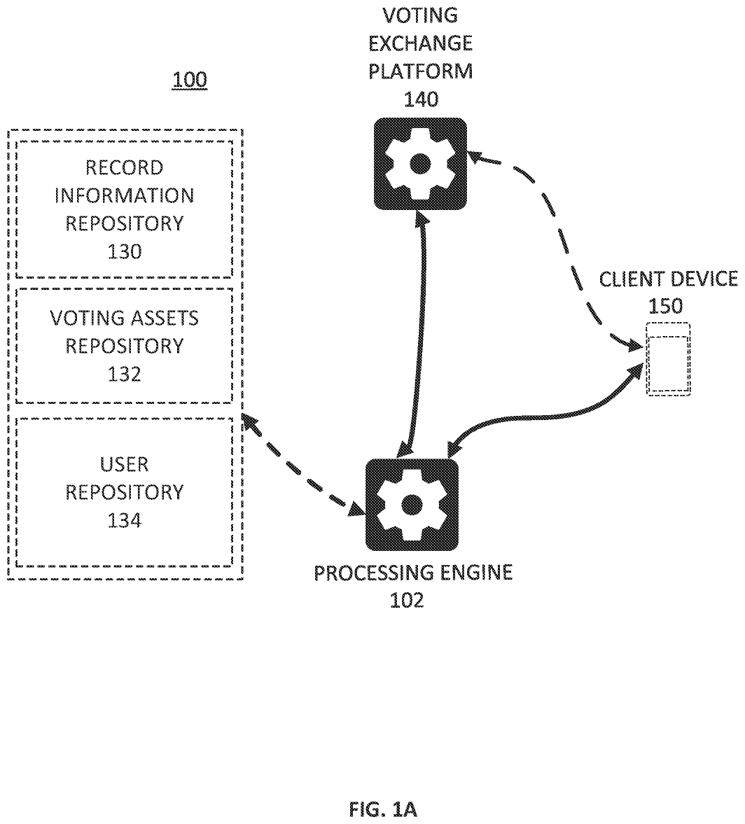

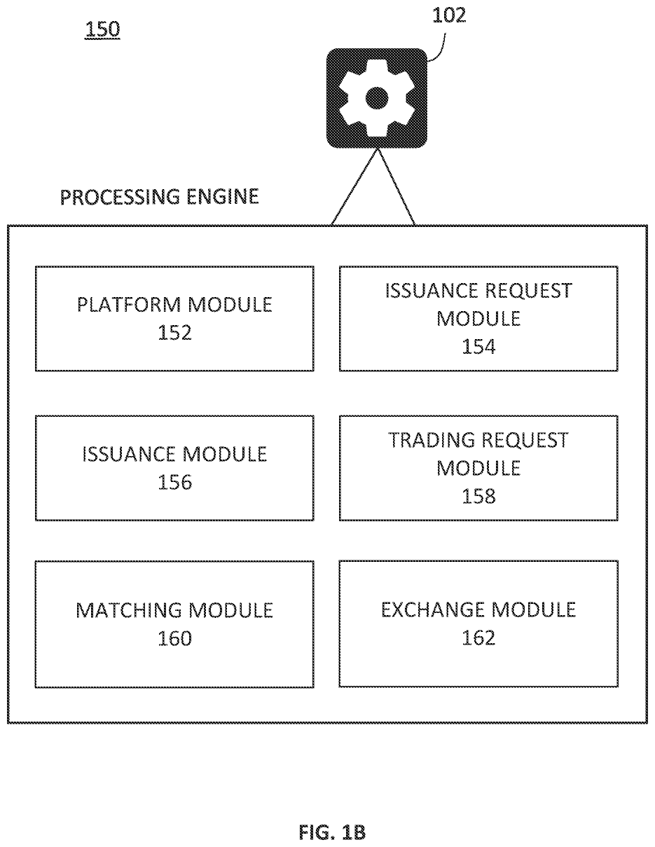

FIG. 1A is a diagram illustrating an exemplary environment in which some embodiments may operate. In the exemplary environment 100, a client device 150 is connected to a processing engine 102 and a voting exchange platform 140. The processing engine 102 is connected to the voting exchange platform 140, and optionally connected to one or more repositories and/or databases, including, e.g., a record information repository 130, a voting assets repository 132, and/or a user repository 134. One or more of the databases may be combined or split into multiple databases. The client device 150 in this environment may be a computer, and the voting exchange platform 140 and processing engine 102 may be applications or software hosted on a computer or multiple computers which are communicatively coupled via remote server or locally.

The exemplary environment 100 is illustrated with only one client device, one processing engine, and one voting exchange platform, though in practice there may be more or fewer additional client devices, processing engines, and/or voting exchange platforms. In some embodiments, the client device(s), processing engine, and/or voting exchange platform may be part of the same computer or device.

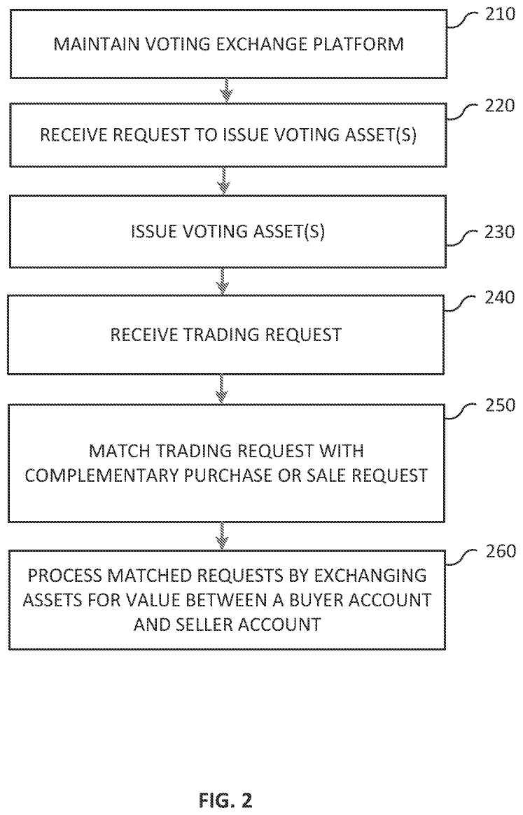

In an embodiment, the processing engine 102 may perform the exemplary method of FIG. 2 or other method herein and, as a result, provide a dynamic voting exchange platform for buying, selling, and trading shareholder voting rights. In some embodiments, this may be accomplished via communication with the client device, processing engine, voting exchange platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The client device 150 is a device capable of capturing, sending, and receiving data. In some embodiments, the client device 150 is configured to capture motion data via one or more sensors attached to or otherwise communicatively coupled to the device, and is further configured to send that motion data to the processing engine 102 and/or voting exchange platform 140, as well as to receive signals from those components. In some embodiments, the client device is a computing device capable of hosting and executing one or more applications or other programs capable of capturing, sending and/or receiving data. In some embodiments, the client device may be a computer desktop or laptop, mobile phone, virtual assistant, virtual reality or augmented reality device, wearable, or any other suitable device capable of capturing, sending, and receiving information. In some embodiments, the processing engine 102 and/or voting exchange platform 140 may be hosted in whole or in part as an application or web service executed on the client device 150. In some embodiments, one or more of the voting exchange platform 140, processing engine 102, and client device 150 may be the same device. In some embodiments, the client device 150 is associated with a first user account within a voting exchange platform, and one or more additional client device(s) may be associated with additional user account(s) within the voting exchange platform.

In some embodiments, optional repositories can include a record information repository 130, a voting assets repository 132, and/or a user repository 134. The optional repositories function to store and/or maintain, respectively, record information corresponding to shareholder voting rights; voting assets issued for shareholder voting rights; and data relating to users of the voting exchange platform and their associated accounts within the platform. The optional database(s) may also store and/or maintain any other suitable information for the processing engine 102 or voting exchange platform 140 to perform elements of the methods and systems herein. In some embodiments, the optional database(s) can be queried by one or more components of system 100 (e.g., by the processing engine 102), and specific stored data in the database(s) can be retrieved.

Voting exchange platform 140 is a platform configured to facilitate the buying, selling, and trading of shareholder voting rights. In some embodiments, the platform is further configured to facilitate authorized entities to exercise shareholder voting rights.

FIG. 1B is a diagram illustrating an exemplary computer system 150 with software modules that may execute some of the functionality described herein. In some embodiments, the modules illustrated are components of the processing engine 102.

Platform module 152 functions to maintain a voting exchange platform.

Issuance request module 154 functions to receive a request from a user to issue one or more voting assets based on voting rights the user is entitled to act upon, the request including record information corresponding to the voting rights.

Issuance module 156 functions to issue voting assets corresponding to the voting rights.

Trading request module 158 functions to receive a trading request corresponding to at least a subset of the issued voting assets, the trading request representing a purchase request or a sale request.

Matching module 160 functions to match the trading request with a complementary purchase request or sale request.

Exchange module 162 functions to process the matched requests by exchanging assets for value between a first account associated with a buyer and a second account associated with a seller.

The above modules and their functions will be described in further detail in relation to an exemplary method below.

FIG. 2 is a flow chart illustrating an exemplary method that may be performed in some embodiments.

At step 210, the system maintains a voting exchange platform. The voting exchange platform has a number of users, and each user is associated with an account. In some embodiments, each user may be associated with one or more accounts. In some embodiments, one or more users may be associated with a single account (e.g., as in the case of an omnibus account utilized by a service provider on behalf of multiple beneficial users). In some embodiments, users may each be one or more of, e.g., an original owner of shareholder voting rights (e.g., the shareholder), an original owner of issued voting assets, a purchaser of issued voting assets from another user, a non-original owner of shareholder voting rights (i.e., the user has purchased issued voting assets from another user, and thus is entitled to act upon the shareholder voting rights which correspond to the issued voting assets), a prospective purchaser, seller, or trader of issued voting assets, a proxy holder of shareholder voting rights entitled to act upon them on behalf of the owner of the shareholder voting rights, a proxy holder of issued voting assets entitled to sell or trade the assets on behalf of the actual owner, a proxy purchaser of issued voting assets on behalf of someone else, or any other potential user of the voting exchange platform seeking to make use of its functions.

As used throughout, voting rights (or simply “voting rights”) refer to the right of a shareholder of record, a beneficial shareholder, a proxy holder, a bond holder, or a non-shareholder owner of voting rights to make voting decisions at a specific corporate meeting of a company. Voting rights may correspond to any such right to vote in corporate meetings or company affairs. A “corporate meeting” as used herein may be, for example, a general company meeting, shareholder meeting, annual general meeting (“AGM”), extraordinary meeting, extraordinary general meeting (“EGM”), special meeting, annual meeting, or any other suitable company or corporate meeting. Voting rights may be measured based on an integer or decimal number of votes, or as a relative percentage of the total outstanding voting power. Issued voting assets (or simply “voting assets” or “assets”) refer to issued assets within the voting exchange platform which can be bought, sold, and/or traded by users of the voting exchange platform, and which correspond to voting rights for a specific corporate meeting. In some embodiments, voting assets may be substantiated by proxies or voting instructions in lieu of direct voting rights. In some embodiments, voting assets may standardize multiple versions of voting rights with the same underlying powers. For instance, voting assets for a particular corporate meeting may bear the same functionality (e.g., with respect to trading, exercising, or the applicability of certain terms and conditions) on the voting exchange platform, although each voting asset may be backed by different sources (e.g., direct voting rights, proxies, or voting instructions) or may be exercised on different third-party voting platforms. A purchaser of issued voting assets will effectively take ownership of the corresponding voting rights, and thus is entitled to make voting decisions at a specific corporate meeting associated with those particular voting rights. In some embodiments, a voting asset can potentially be backed by the voting rights for multiple shares owned by a shareholder of common stock of a company (for example, 1 voting asset can be backed by voting rights for 100 shares owned by a shareholder), while in other embodiments, each voting asset can be backed by the voting rights for only a single share owned by a shareholder of common stock of a company (for example, 100 voting assets are backed by 100 shares).

One key aspect of the system herein is that a voting asset may be traded or owned independently of any associated stock or assets which entitle an owner thereof to voting rights which can be used to issue voting assets. That is, a voting asset can be held by a user who does not hold the associated stock or assets, and conversely, a holder of stock or assets may not necessarily hold the voting rights associated with that stock or those assets. One of the improvements the system provides is in enabling shareholders to sell just the voting rights which accrue to them as part of holding the stock or assets, and enabling interested parties to hold just the voting assets entitling them to act with respect to the voting rights pursuant to corporate meetings, but not the associated stock. By selling a voting asset to another entity via the voting exchange platform, a user may appoint that entity as their proxy or authorized agent with respect to the voting rights of the voting asset being sold.

In some embodiments, the voting exchange platform is maintained by a maintaining entity, which may be one or more of the developer, host, provider, and/or publisher of the voting exchange platform. The voting exchange platform may be hosted on one or more servers, and may be communicatively connected to one or more local or remote databases, websites, or applications acting as repositories of data, information, and/or assets.

In some embodiments, an account associated with a user may hold a balance. A balance may be any amount (including a zero amount or, in some embodiments, a negative amount) and may represent an amount of economic value tied to a specific currency. In some embodiments, an account may be associated with one or more holdings, which refers to voting assets currently held by the user via the exchange platform. Balances and holdings will be described in further detail below. In various embodiments, an account of a user may additionally bear information including user voting decisions, preferences, settings, services, licenses, subscriptions, or other identifying pertaining to the user.

At step 220, the system receives a request from a user to issue one or more voting assets based on voting rights the user is entitled to act upon, the request including record information corresponding to the voting rights entitled to the user or pertaining to a corporate meeting associated with the voting rights.

In various embodiments, a user may be any party that is a user of the voting exchange platform or is associated with a user account within the voting exchange platform. In some embodiments, the user is authorized and entitled to act with respect to voting rights, including one or more of, e.g., exercising the voting rights as voting decisions, selling the voting rights, assigning a proxy to act on behalf of themselves, or abstaining from voting. A user may also be authorized to act on behalf of other persons (i.e., shareholders) who are entitled to act with respect to voting rights.

In some embodiments, the request to issue the one or more voting assets is received electronically. In some embodiments, the request is submitted via a user interface of the voting exchange platform which provides an electronic form to be filled out and submitted. In other embodiments, the request may be submitted via one or more of electronic mail, electronic message(s), a non-electronic physical form (e.g., a paper form) which can be submitted via physical mail, or any other suitable electronic or non-electronic forms of transmitting the request.

In some embodiments, the request to issue the one or more voting assets may be submitted by a user by completing an issuance form or proxy form, or by providing access to an online access point. In some embodiments, an issuance form or proxy form is presented to the user entitled to act upon certain voting rights. In some embodiments, the issuance request may include a number of terms and conditions to be agreed upon by the user. By initiating an issuance request, the user may agree to such terms and conditions. The system receives the completed issuance form, proxy form, or access to an online access point. In some embodiments, the online access point may be an email address, brokerage account, or other online account which receives information pertaining to voting rights of the user, the user's client, or the user's principal. The system may utilize the online access point to receive information pertaining to the voting rights.

In some embodiments, upon receiving a request to issue voting assets backed by certain voting rights, proxy rights, or voting instructions, information pertaining to the request is stored within a database. In some embodiments, the system may present such information to a requesting party. In various embodiments, the requesting party may be one or more of, e.g., the owner of the voting assets, the owner of the shares associated with the voting rights, another user, or an agent designated by the company. In response to the request, the system can present the completed issuance form, proxy form, or other information associated with the voting assets.

The request to issue one or more voting assets includes record information corresponding to the voting rights entitled to the user or pertaining to a corporate meeting associated with the voting rights. Record information may be any information associated with a registered shareholder on record, a beneficial shareholder holding their shares indirectly through a broker-dealer or bank, a proxy thereof, or other user or authorized entity with respect to voting rights pertaining to a corporate meeting associated with such voting rights. In various embodiments, record information may include one or more of: a control number (e.g., a 10-20-digit number), a Committee on Uniform Securities Identification Procedures (“CUSIP”) number, a corporate meeting date, the name or stock ticker symbol of a company holding the corporate meeting, information identifying the user (e.g., the name of the user), a proxy form, a voting instruction form, a voting agreement, or a voting trust certificate.

At step 230, the system issues voting assets corresponding to the voting rights pursuant to a corporate meeting.

In some embodiments, the process of issuing voting assets includes the creation of a voting asset which, in some embodiments, may be a data object stored in a database maintained by the voting exchange platform. The voting asset being created is backed by the voting rights of a shareholder, bondholder, or other person bearing voting rights (including, e.g., a proxy) relating to a corporate meeting. In some embodiments, the issuance process requires a user to agree to a set of terms, through which they agree to back the voting asset with their voting rights for the meeting. In some embodiments, backing the voting asset with voting rights may involve creating or signing a proxy form or voting instruction form. In backing a voting asset, a user pledges or commits their voting rights, proxy rights, or voting instruction rights to the owner of the voting asset. The terms and conditions involved with backing a voting asset may include provisions regarding exclusivity, irrevocability, and termination of such backing.

In some embodiments, the voting rights being assigned in the issued voting asset are temporary, in the sense that they only correspond to a particular corporate meeting on a particular date. In some embodiments, the assets may be either revocable or irrevocable, depending on user preferences and other factors (e.g., such as whether the user has an interest in the corporation generally).

In some embodiments, the process of issuing a voting asset includes verifying the accuracy of the record information to determine the validity, duration, and other attributes of the voting rights associated with the issuance request. In some embodiments, verifying the accuracy of the record information includes determining that the user is a registered shareholder of record or a beneficial shareholder of the corporation holding the corporate meeting.

In some embodiments, verifying the accuracy of the record information includes cross-referencing information (i.e., the record information submitted with the request) with information from one or more databases or websites. In various embodiments, such databases or websites may be maintained as part of, or external to, the voting exchange platform, and may be maintained by the maintaining entity of the voting exchange platform or another third-party entity.

In some embodiments, verifying the accuracy of the record information includes determining that the associated voting rights have not been previously pledged to back other voting assets. That is, if the record information submitted with the request matches the record information of one or more previously issued voting assets, then the issuance secondary request will be denied.

In some embodiments, verifying the accuracy of the record information includes checking if a user is or was a shareholder on record with a transfer agent or registrar, or if a user is or was a beneficial shareholder.

At step 240, the system receives a trading request corresponding to at least a subset of the issued voting assets, the trading request representing a purchase request or a sale request.

In some embodiments, a trading section of the voting exchange platform is displayed for the user. The trading section can include, for example, a trading chart including price and volume values for voting assets related to a specific corporate meeting within specific time frames, an order book showing current orders available within the exchange, and an order entry section allowing the user to submit trading requests, including purchase requests (i.e., buy order requests) in the case of a prospective buyer of voting assets, or sale requests (i.e., sell order requests) in the case of a prospective seller or trader of voting assets. In some embodiments, a trading request may be one or more of a market order, a limit order, a stop order, or a stop-limit order. For example, a sell limit order may involve a request to sell at least a subset of voting assets at a specified selling price or higher.

In some embodiments, the trading request is received electronically. In some embodiments, the trading request is submitted via a user interface of the voting exchange platform which provides an electronic form to be completed or submitted. In other embodiments, the trading request may be submitted via one or more of electronic mail, electronic message(s), a non-electronic physical form (e.g., a paper form) which can be submitted via physical mail, or any other suitable electronic or non-electronic forms of transmitting the request.

In some embodiments, the trading request may include a specification of whether to buy or sell assets, a number of assets to buy or sell, and a buying or selling price for the assets. The order will then be submitted by the user, and if approved by system requirements, will appear on the order books within the exchange.

In some embodiments, a sale request may include one or more terms which a prospective buyer must agree to be bound to in order to proceed with the purchase. In some embodiments, such terms may include one or more of: an agreed-upon expiration date for the voting assets, one or more proposals associated with the voting assets, one or more rights obtained upon purchasing, whether the associated voting rights or associated proxy form are revocable or irrevocable, and prohibition of resale of the voting assets.

At step 250, the system matches the trading request with a complementary purchase request or sale request.

If a sell order on the books (submitted by a seller in step 240) matches with a buy order on the books (submitted by a buyer in step 240), then the trading request of the sale matches with the complementary purchase request, and the orders execute for additional processing. In some embodiments, the system may increase efficiency in this process by matching more than two orders as part of the same matching process. For instance, one buy order may be matched with two sell orders, or vice versa.

At step 260, the system processes the matched requests by exchanging assets for value between a first account associated with a buyer and a second account associated with a seller.

In some embodiments, processing the matches requests includes initiating settlement and transfer activities. Settlement activities can include settling the purchase order by transferring required funds for the purchase from the first account associated with the buyer, to the second account associated with the owner or seller. Transfer activities can include transferring the ownership of the voting assets and the associated voting rights from the owner to the buyer. In some embodiments, exchanging assets for value can include transferring one or more voting assets from an account associated with the seller to an account associated with the buyer, and transferring economic value from the account associated with the buyer to the account associated with the seller. In various embodiments, a value of zero economic value may be transferred, so that the buyer of the voting assets may receive the voting assets at no direct cost. In lieu of transferring a value of zero economic value, the system may instead omit such a transfer, although it may still complete the transfer of voting assets from the seller to the buyer.

In some embodiments, the settlement and transfer activities are delayed for a pre-determined period of time or are conditioned upon the occurrence or non-occurrence of at least one pre-specified action. In some embodiments, the pre-specified action may be a vote audit to ensure votes were properly exercised (i.e., submitted, cast, or otherwise exercised in a valid way or in accordance with the final preferences of their rightful owner). In various embodiments, the vote audit may be manually performed, automated, or semi-automated. In some embodiments, the delay results in the economic value being transferred from buyer to seller being categorized as “unsettled funds”. In some embodiments, unsettled funds represent proceeds that the user has received from selling their voting assets. These transactions and unsettled funds settle after vote auditing is completed, in order to provide recourse for asset holders in cases of vote-tampering or fraud. In some embodiments, when assets are sold for the first time, funds are considered to be unsettled for this initial transaction, until a vote audit (or simply “audit”) is performed. In subsequent (i.e., noninitial) sales of the voting assets, however, funds associated with the sale transaction will be settled immediately and accrue to the user's available funds. Since the original, first seller is the only person with access to the record information needed to exercise the voting rights, they may be held accountable if there is an issue anywhere down the chain of selling or reselling, e.g., someone else voted with a person's assets, tried to override the asset owner's voting submissions, or performed another action prohibited by the terms and conditions.

In some embodiments, presenting a user interface for the user to submit voting decisions to exercise voting rights corresponding to at least one voting asset for a corporate meeting, the at least one voting asset being held by an account associated with the user on the voting exchange platform.

In some embodiments, various aspects of the steps described above can be implemented using blockchain techniques. In one implementation, valid issuance and trading requests could be recorded as transactions that compose blocks in the blockchain. Valid issuance requests could result in the creation of a voting crypto-currency (similar to voting assets), while trading activities could be implemented through the transfer of a voting crypto-currency from one virtual wallet to another (perhaps in exchange for compensation). In another implementation, valid voting requests could be stored as transactions on the blockchain, ensuring that votes can be audited against a reliable ledger of voting records from the past. Other protocols like delayed settlement and voting asset expiration could also be implemented using smart contracts. A smart contract program may delay the settlement of certain transactions until other actions (i.e. vote auditing) have been performed. Similarly, a smart contract program could be used to facilitate the expiration of certain voting crypto-currencies, preventing further trading or voting activities involving those assets.

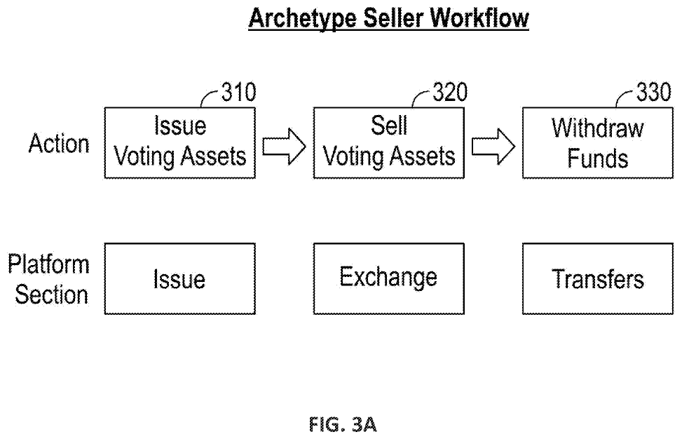

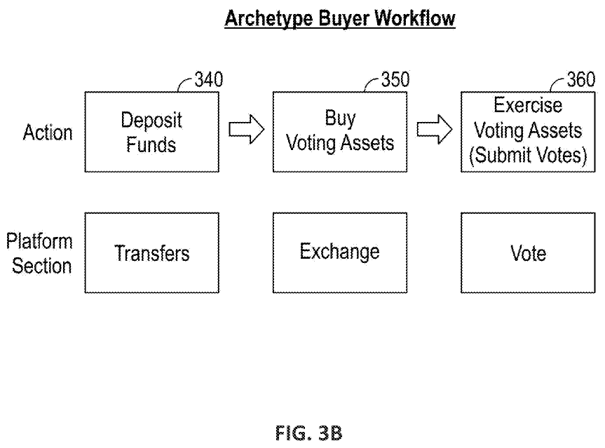

FIGS. 3A and 3B illustrate an archetype seller workflow and archetype buyer workflow, respectively, within the voting exchange platform according to some embodiments herein.

FIG. 3A is a diagram illustrating one example embodiment of a seller workflow, in accordance with some embodiments.

In the archetype seller workflow illustrated in the figure, actions taken are paired with potential platform sections of a voting exchange platform. First, at step 310, the seller uses the issuance section of the platform to request issuance of voting assets, and includes record information with the issuance request, such as a CUSIP number, the seller's name, and other pieces of information. Then the system issues the voting assets requested. At step 320, the seller submits, on the exchange portion of the platform, a trading request in the form of a sell order, including such information as number of votes to sell and the offered price per vote. At step 330, upon one or more of the voting assets being sold to a purchaser and funds accruing to the seller's account, the seller withdraws the funds from the transfers section of the platform.

FIG. 3B is a diagram illustrating one example embodiment of a buyer workflow, in accordance with some embodiments.

In the archetype buyer workflow illustrated in the figure, actions taken are paired with potential platform sections of the voting exchange platform, similar to the archetype seller workflow of FIG. 3A. First, at step 340, the buyer deposits funds into their account, using the transfers section of the platform. In various embodiments, the buyer may deposit funds using, e.g., wire transfer, Automated Clearing House (“ACH”) transfer, a funds transfer service, or other suitable option for depositing funds into the seller's account on the platform. Next, at step 350, the buyer buys voting assets that have been offered up for sale, using the exchange platform. At step 360, the buyer exercises the voting assets by submitting votes on a voting section of the platform.

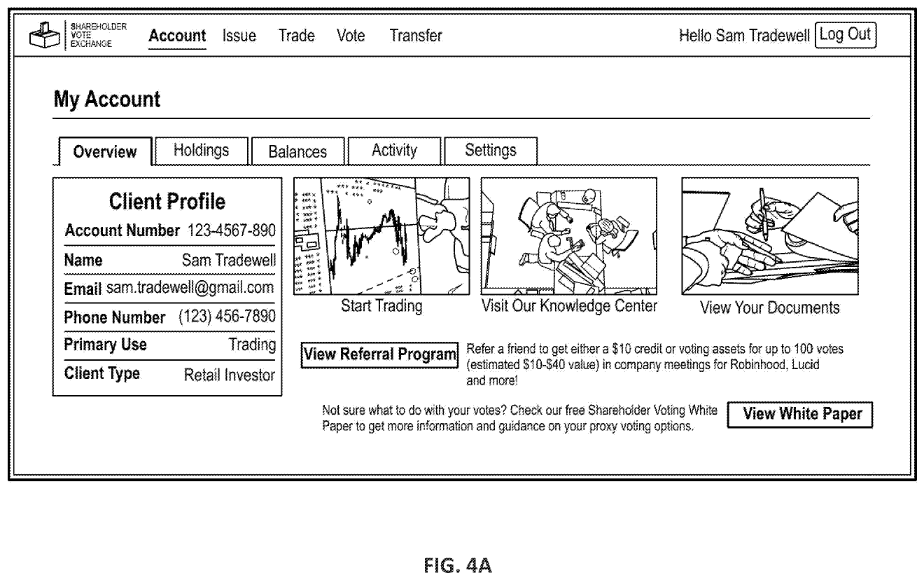

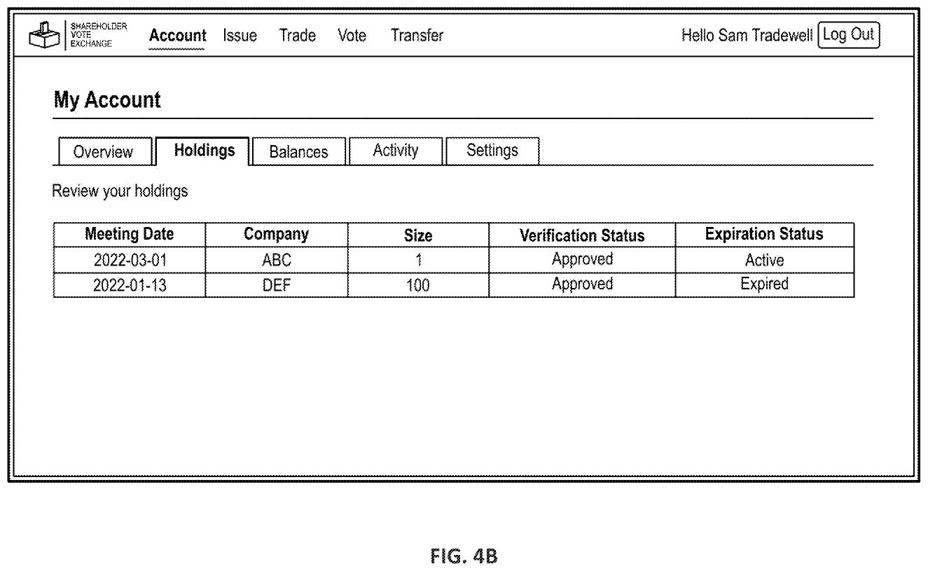

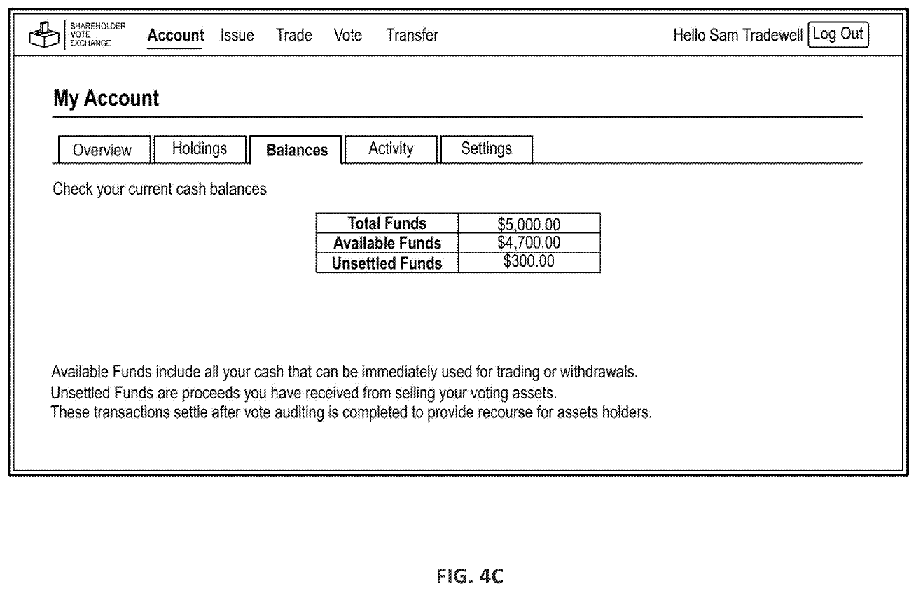

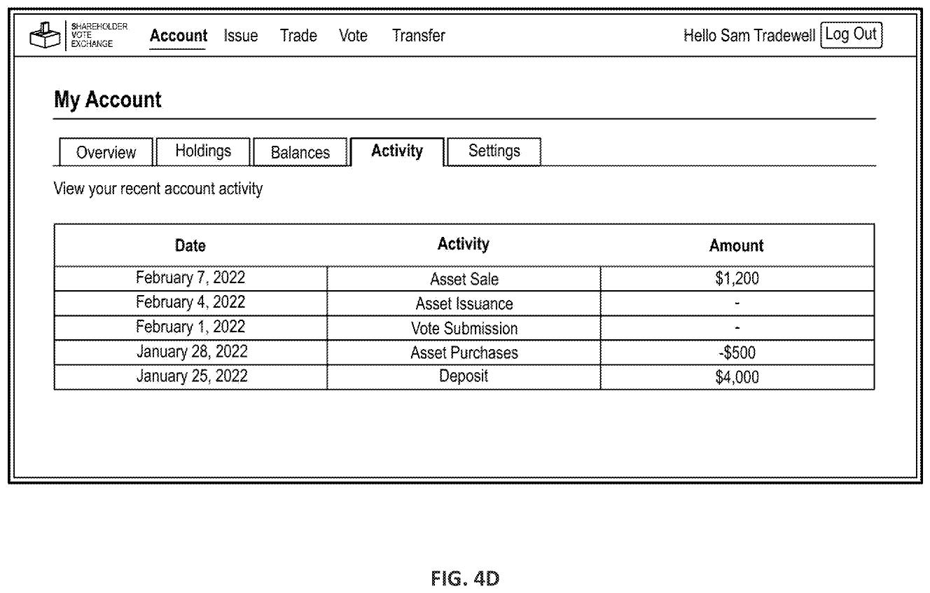

FIGS. 4A-4D illustrate sections of the voting exchange platform related to a user and their account, including an account overview page, holdings page, balances page, and activity page.

FIG. 4A is a diagram illustrating one example embodiment of an account overview page in a voting exchange platform, in accordance with some embodiments.

Within the illustrated account overview page, a user, upon logging into the voting exchange platform, is greeted with their client profile showing key information about their account, including, e.g., an account number, name of the user, email, phone number, primary use of the voting exchange platform, and client type. Tabs above the client profile include the currently active overview section, as well as holdings, balances, activity, and settings sections. The user may also navigate to a knowledge center for information on subjects including buying and selling voting assets, or start trading by navigating to an exchange section of the platform. A referral program is also offered for a user to invite friends by sharing a unique link, and access to a white paper on proxy voting is additionally provided.

FIG. 4B is a diagram illustrating one example embodiment of an account holdings page in a voting exchange platform, in accordance with some embodiments.

The account holdings page illustrated in the figure presents the user with the voting assets that the user owns. Information for each asset is presented, including, e.g., the corporate meeting date, the name of the company whose corporate meeting is being held, the number of votes or voting assets held by the user, the verification status for a verification check that has been performed, and expiration status of the assets, i.e., whether the associated voting rights are active for an upcoming corporate meeting, or have expired. The holdings page for the user in the example shows that the user is holding 1 currently active voting asset for company ABC, and one set of expired voting assets for company DEF.

FIG. 4C is a diagram illustrating one example embodiment of an account balances page in a voting exchange platform, in accordance with some embodiments.

The account balances page illustrated in the example shows the total funds, available funds, and unsettled funds in the user's account. As the statement on the page explains, available funds include all of the cash (i.e., economic value in a given currency) that the user can immediately use for trading or withdrawals. In some embodiments, unsettled funds represent proceeds that that user has received from selling their voting assets, as described above.

FIG. 4D is a diagram illustrating one example embodiment of an account activity page in a voting exchange platform, in accordance with some embodiments.

The account activity page illustrated in the example shows all recent account activity, including, e.g., deposits, withdrawals, asset purchases, asset sales, asset issuances, and vote submissions. In this example, the user has been active in an asset sale in the amount of $1,200, an asset issuance, a vote submission, an asset purchase in the amount of $500, and a deposit of $4,000. For each activity, the date, type of activity, and amount in economic value (if applicable) are presented.

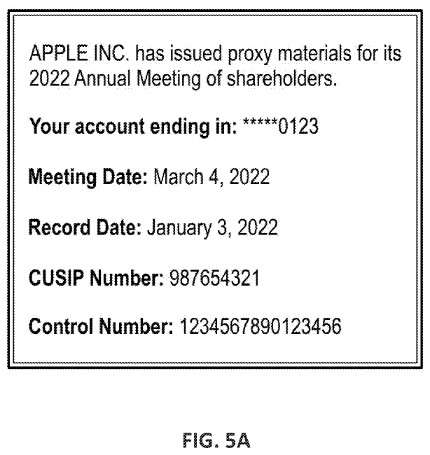

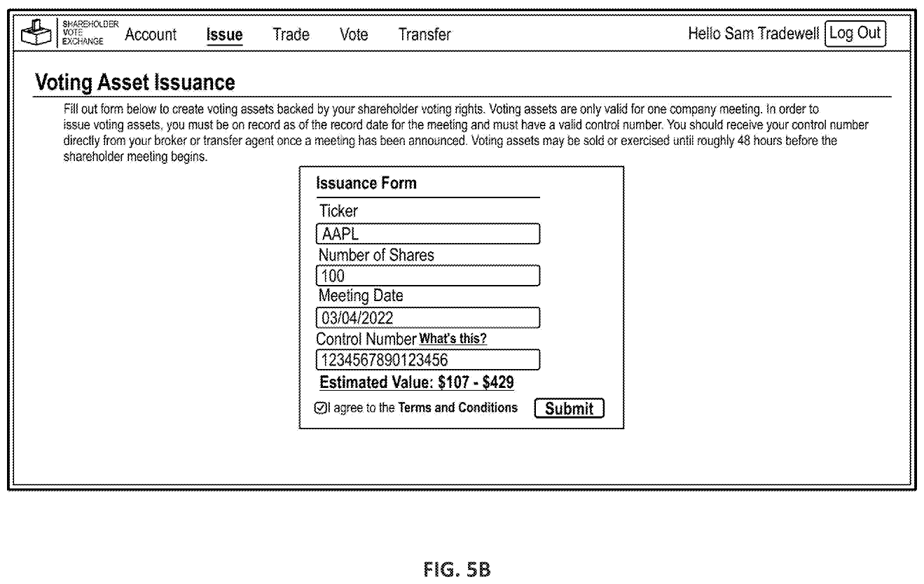

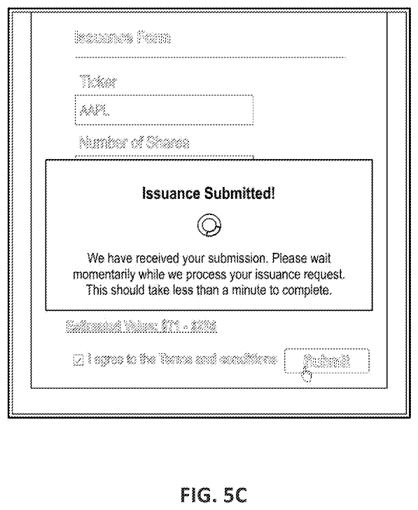

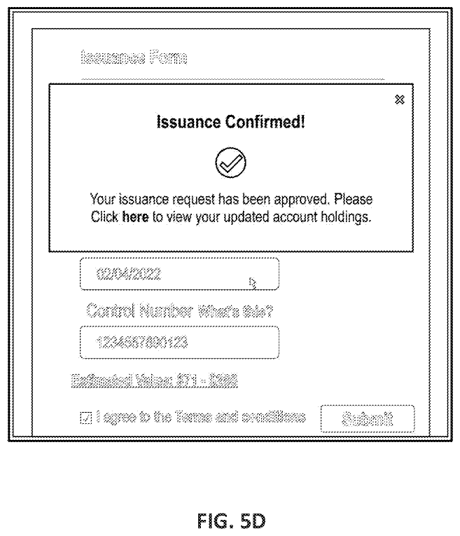

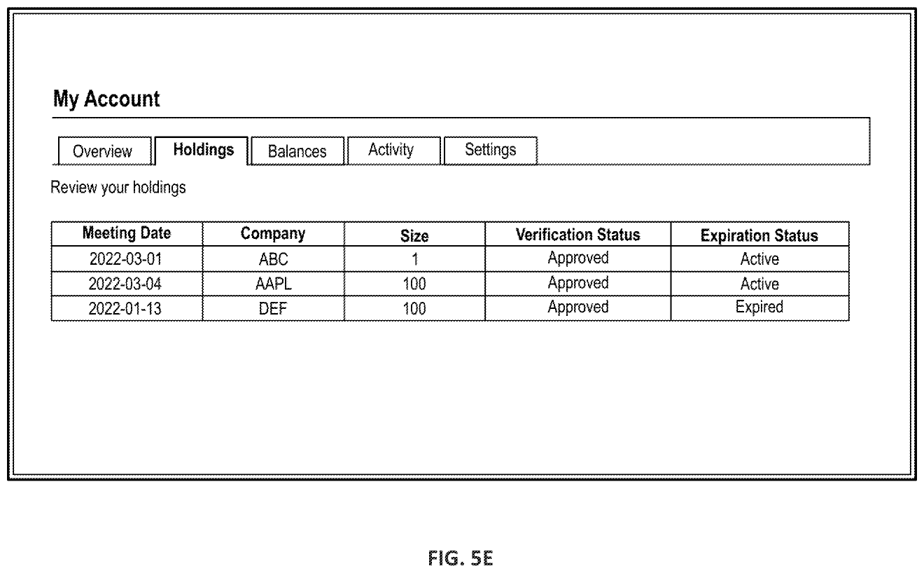

FIGS. 5A-5E illustrate an example workflow for issuing voting assets.

FIG. 5A is a diagram illustrating one example embodiment of record information associated with shareholder voting rights, in accordance with some embodiments.

In the example, a portion of an email to a person is shown. The person has been issued proxy materials from the company AAPL for its 2022 annual meeting of shareholders. Record information is provided in an email for the person. The last 4 digits of the person's AAPL account number, the corporate meeting date, the record date (i.e., date upon which the person was on record as a shareholder with voting rights), the CUSIP number, and the control number. The person receiving the email is entitled to vote in the upcoming corporate meeting. If the same person (or their authorized representative) requests issuance of voting assets for these voting rights, then in some embodiments, the issuance form may request, for example, the control number and the corporate meeting date. Based on the control number, the system can ascertain that the company in question is Apple. In some embodiments, the system may need to only ask for the control number to verify that the person is on record. However, additional information may be requested or required in order to further verify details.

FIG. 5B is a diagram illustrating one example embodiment of requesting issuance of voting assets in a voting exchange platform, in accordance with some embodiments.

In the illustrated example, an issuance form is presented for the user to fill out in order to submit a request to issue voting assets. The issuance form includes text fields for the user to fill out the ticker (i.e., company stock ticker symbol), number of shares (i.e., number of voting assets to be issued), corporate meeting date for the corporate meeting pursuant to the voting rights, and control number on record. In some embodiments, an estimated value of the votes is provided, which pertains to the voting assets to be issued. In some embodiments, this value is derived from the share price and the number of votes backing the voting assets. Upon completing the form, the user may agree to terms and conditions, then interact with a “submit” button.

FIG. 5C is a diagram illustrating one example embodiment of an issuance request being submitted in a voting exchange platform, in accordance with some embodiments. Upon the issuance form in FIG. 5B being completed and submitted by the user, a message is displayed showing that the issuance has been submitted.

FIG. 5D is a diagram illustrating one example embodiment of an issuance request being confirmed in a voting exchange platform, in accordance with some embodiments. After the issuance is submitted, a verification process may be performed to ensure that the information submitted is genuine, i.e., matches with genuine record information for voting rights in an upcoming corporate meeting.

In some embodiments, this check may be performed by the system entering information, such as the control number, into a first-party or third-party voting platform where the voting rights being verified may be exercised. The system will attempt to input the control number on the voting platform to determine its validity, then will check the other information provided, if any. For example, the system may determine how many shares the control number corresponds to, when the meeting date is, what company the votes are for, and any other suitable information, and check that it matches to the information provided in the issuance request. In some embodiments, the system may also determine whether the asset(s) have been previously issued and whether the voting rights have already been exercised. In some embodiments, while the system performs these checks on the voting platform, it may also record information about the voting topics or proposal, so that a user may be able to exercise their voting assets on the platform in the future. In some embodiments, this information is derived from information contained within the proxy statement issued by the company for the relevant meeting.

If the system determines that the submitted information is genuine, then the issuance is confirmed. As illustrated, a message that the issuance has been confirmed can be presented. In some embodiments, the user may click on the message to navigate to their account holdings page to view the issued assets.

If the system determines that the submitted information is not genuine, or otherwise cannot match the information with record information on the relevant voting platform, then the issuance will be rejected. The user may wish to try resubmitting the information or performing another task within the platform.

FIG. 5E is a diagram illustrating one example embodiment of a holdings page being updated with newly issued voting assets in a voting exchange platform, in accordance with some embodiments. In the holdings page, the newly issued voting assets for the AAPL corporate meeting on 2022-03-04 is presented as active, with verification approved. In some embodiments, these assets may then be traded or exercised on the voting exchange platform.

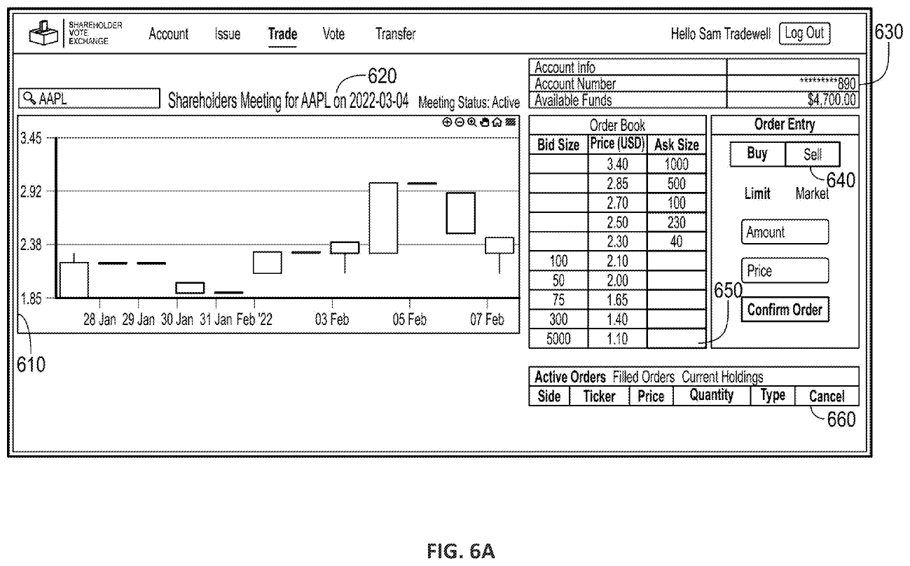

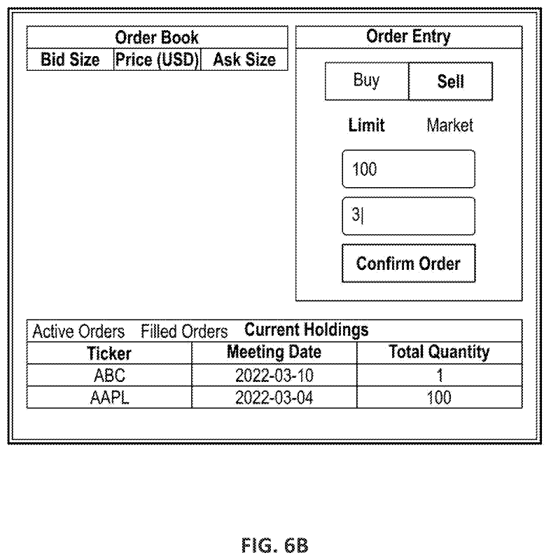

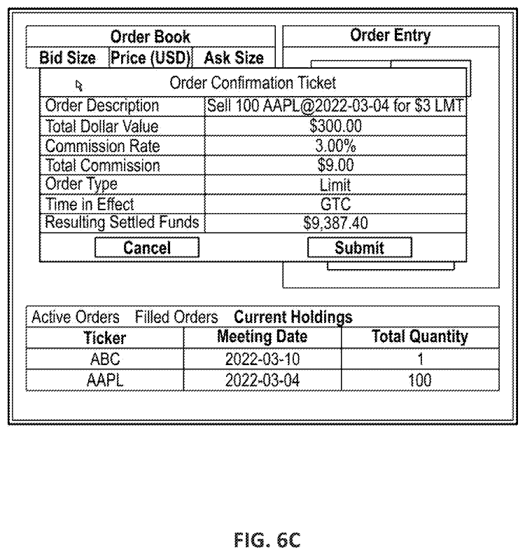

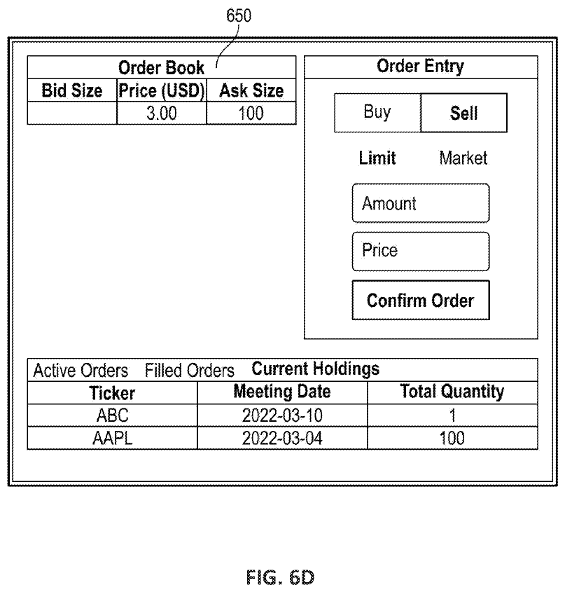

FIGS. 6A-6D illustrate an example workflow for selling voting assets on the voting exchange platform.

FIG. 6A is a diagram illustrating one example embodiment of a trading page in a voting exchange platform, in accordance with some embodiments.

The illustrated trading page displays a wealth of information related to trading for the user. A trading chart 610 shows the trading trends for a particular company's voting assets within a particular time frame. A user may navigate the trading chart to display opening, closing, high, and low prices for voting assets for the company on a particular day. Active meetings 620 are also displayed. When a user is logged in, their account information 630 is displayed, including a portion of their account number and their current available funds. The user may also use the order entry section 640 to place buy or sell orders. In various embodiments, trading orders may include one or more of, e.g., a market order, a limit order, a stop order, and a stop-limit order. An order book 650 presents orders to the user for each different market (i.e., each corporate meeting for each company). An information section 660 allows the user to see their current holdings, which of their orders have been filled, and which of their orders are active. The user may also interact with buttons in this section to cancel any of their active orders.

FIG. 6B is a diagram illustrating one example embodiment of a sell order entry being submitted in a voting exchange platform, in accordance with some embodiments.

In the illustrated section for trading, current holdings of the user are shown at the bottom. The user has selected to sell voting assets, and has input the number of assets to sell, as well as a price per asset to sell the voting assets at.

FIG. 6C is a diagram illustrating one example embodiment of a sell order entry being confirmed in a voting exchange platform, in accordance with some embodiments.

A sell order confirmation ticket is displayed, with information about the requested order which the user may view before submitting the sell order request. The information includes an order description (i.e., “Sell 100 AAPL @ 2022-03-04 for $3 LMT”), a total dollar value, a commission rate, total commission, order type, time in effect, and resulting settled funds. The user may then interact with either “cancel” or “submit” buttons to cancel the order or proceed with submission of the sell order request.

FIG. 6D is a diagram illustrating one example embodiment of an order book displaying a new sell order entry in a voting exchange platform, in accordance with some embodiments. The sell order request from FIG. 6C has been submitted and approved, and the sell order appears on the order book for all users to view.

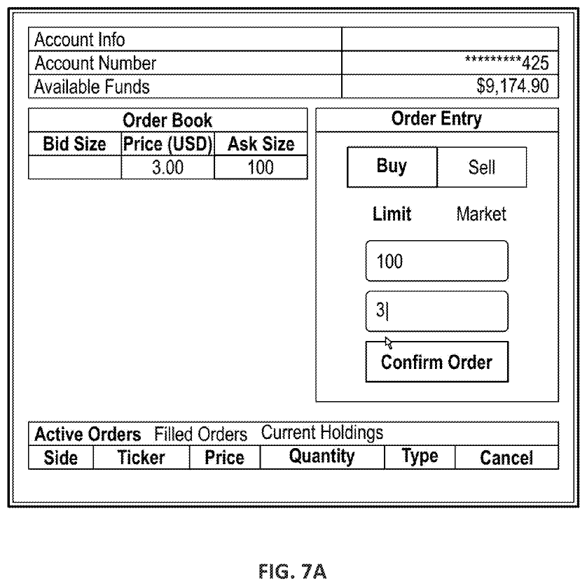

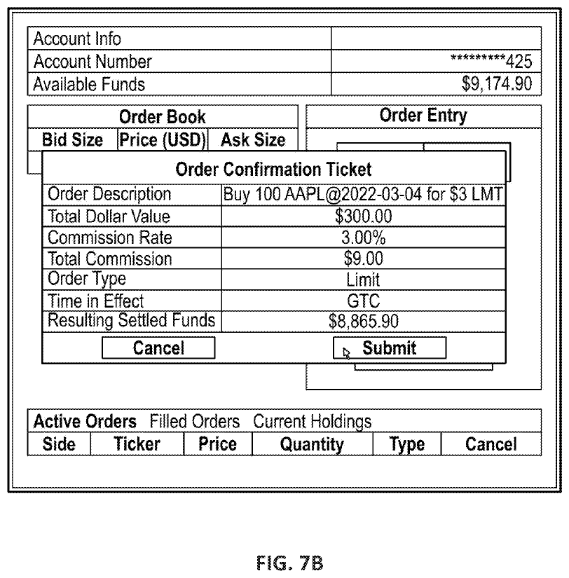

FIGS. 7A-7B illustrate an example workflow for buying voting assets via a voting exchange platform, in accordance with some embodiments.

FIG. 7A is a diagram illustrating one example embodiment of a buy order entry being submitted in a voting exchange platform, in accordance with some embodiments.

In the illustration, the sell order from FIG. 6D is displayed within the order book of a user, i.e., a prospective buyer. The user has clicked on the “buy” button in the order entry section, and requests to buy 100 shares of AAPL votes at $3 per share. The user then clicks the “confirm order” button to proceed.

FIG. 7B is a diagram illustrating one example embodiment of a buy order entry being confirmed in a voting exchange platform, in accordance with some embodiments.

A buy order confirmation ticket is displayed, with information about the requested order which the user may view before submitting the buy order request. The information includes an order description (i.e., “Buy 100 AAPL @ 2022-03-04 for $3 LMT”), a total dollar value, a commission rate, total commission, order type, time in effect, and resulting settled funds. The user may then interact with either “cancel” or “submit” buttons to cancel the order or proceed with submission of the buy order request.

Since the sell order from FIG. 6D as well as the buy order from FIG. 7B are both on the order book at this point, and have complementary attributes (i.e., same ticker, same meeting date, and overlapping price limits), the exchange will execute. The holdings page of the buyer will now display 100 voting assets for the 2022-03-04 AAPL meeting. In some embodiments, the maintaining entity of the voting exchange platform will take a commission according to a specified rate, e.g., 3.00%. In some embodiments, the system will update a database with the new registered owner of the asset, and all successful trades on orders, current price, and any other relevant information to be updated.

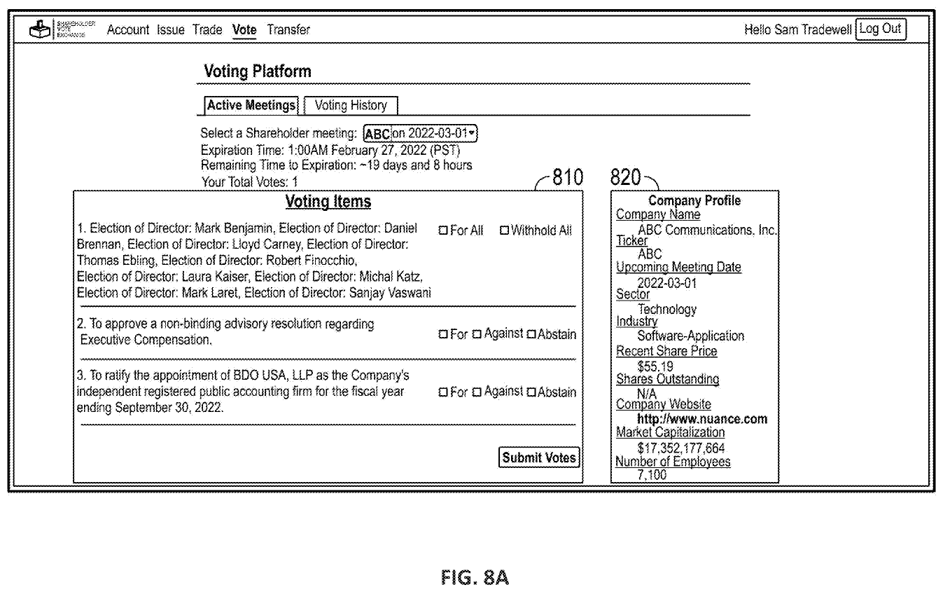

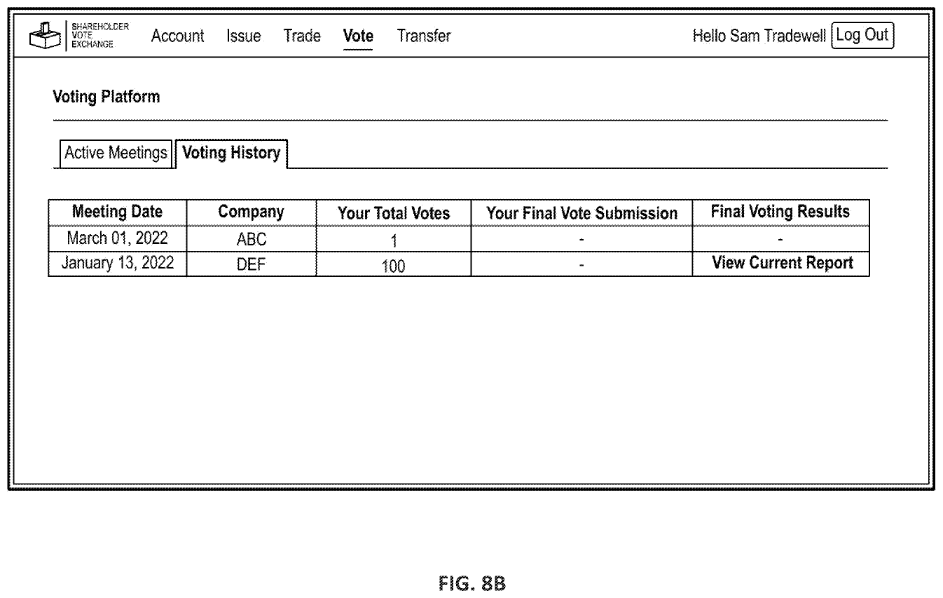

FIGS. 8A-8B illustrate an example workflow of exercising votes via the voting exchange platform.

FIG. 8A is a diagram illustrating one example embodiment of an active meeting voting page in a voting exchange platform, in accordance with some embodiments.

Corporate meetings for which users may vote are listed on the active meeting voting page for the submitting of voting decisions. The active meeting voting page displays to the user how many votes the user holds, and in some embodiments, also shows how much time is left to submit those votes before the votes expire. In some embodiments, some or all voting assets are temporary and will expire at prespecified cutoff times pursuant to their associated corporate meetings, after which the voting assets may not be traded or exercised within the voting exchange platform.

In some embodiments, the voting exchange platform may provide the functionality of a universal voting platform that is compatible with one or more third-party voting platforms. This functionality may benefit users who are entitled to voting rights across multiple voting platforms but seek to efficiently exercise all their voting rights via a single universal platform. In some embodiments, users who own voting assets may submit their voting preferences using the interface on the active meeting voting page. The system may utilize record information associated with voting assets or the user to submit voting preferences for each voting asset to certain third-party voting platforms. In some embodiments, in the performance of a vote audit, the system may utilize record information to receive or check the ultimate submission of voting preferences for each voting asset, ensuring that the final submission was made in accordance with the preferences of the corresponding owner of the voting asset.

Voting items section 810 shows a number of voting topics and proposals, as well as the voting choices for those topics and proposals. In some embodiments, the system pulls this information in from a first-party or third-party voting platform for the voting assets being exercised. In some embodiments, this information is derived from the proxy statement corresponding to the corporate meeting, which may be found on a public database such as the Electronic Data Gathering,

Analysis and Retrieval system (“EDGAR”) maintained by the U.S. Securities and Exchange Commission (“SEC”). A company profile 820 shows information related to the company whose votes are being exercised.

FIG. 8B is a diagram illustrating one example embodiment of a voting history page in a voting exchange platform, in accordance with some embodiments. Recent corporate meeting dates are displayed, with the user's total number of votes for each meeting, the final vote submission for each meeting, and final voting results in a linked report, if applicable. If a user did not vote in a meeting, the final vote submission may be blank, as illustrated.

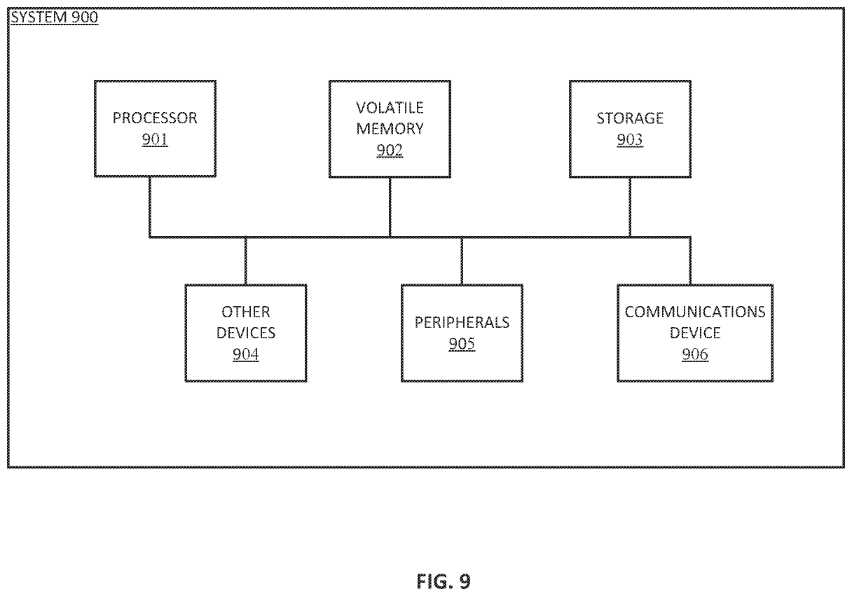

FIG. 9 is a diagram illustrating an exemplary computer that may perform processing in some embodiments. Exemplary computer 700 may perform operations consistent with some embodiments. The architecture of computer 700 is exemplary. Computers can be implemented in a variety of other ways. A wide variety of computers can be used in accordance with the embodiments herein.

Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Peripherals 705 may include removable media devices such as CD-R and DVD-R recorders/players. Communications device 706 may connect the computer 100 to an external medium. For example, communications device 706 may take the form of a network adapter that provides communications to a network. A computer 700 may also include a variety of other devices 704. The various components of the computer 700 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method, comprising:
maintaining a voting exchange platform comprising a plurality of users, each associated with an account;
receiving a request from a user to issue one or more voting assets based on one or more voting rights, the request comprising record information corresponding to the voting rights pursuant to a corporate meeting;
issuing voting assets corresponding to the voting rights pursuant to the corporate meeting;
receiving a trading request corresponding to at least a subset of the issued voting assets via the voting exchange platform, wherein the trading request represents one of a purchase request or a sale request;
matching the trading request with a complementary purchase request or sale request; and
processing the matched requests by exchanging assets for value between a first account associated with a buyer and a second account associated with a seller on the voting exchange platform.

2. The method of claim 1, wherein the user comprises at least one of a shareholder of record, a beneficial shareholder, a proxy holder, a bond holder, a non-shareholder, or a user authorized to act with respect to the voting rights.

3. The method of claim 1, wherein a voting asset may be traded or owned independently of any associated stock or assets which entitle an owner thereof to voting rights which can be used to issue voting assets.

4. The method of claim 1, wherein issuing a voting asset comprises verifying the accuracy of the record information to determine the validity of the voting rights or the associated request.

5. The method of claim 4, wherein verifying the accuracy of the record information comprises checking if a user is or was a shareholder on record with a transfer agent or registrar, or if a user is or was a beneficial shareholder.

6. The method of claim 1, wherein the issuance request is transmitted via one or more of: electronic mail, electronic message, physical mail, or via the voting exchange platform.

7. The method of claim 1, wherein record information comprises at least one or more of: a control number, a CUSIP number, a corporate meeting date, the name or stock ticker symbol of a company holding the corporate meeting, information identifying the user, a proxy form, a voting instruction form, a voting agreement, or a voting trust certificate.

8. The method of claim 1, wherein each voting asset is temporary and expires at a specified cutoff time pursuant to the associated corporate meeting, after which the voting assets may not be traded or exercised within the voting exchange platform.

9. The method of claim 1, wherein processing the matched requests comprises:
initiating settlement and transfer activities, comprising:
settling the purchase order by transferring required funds for the purchase from the first account associated with the buyer to the second account associated with the owner or seller; and
transferring the ownership of the voting assets and the associated voting rights from the owner to the buyer.

10. The method of claim 9, wherein the settlement and transfer activities are delayed for a fixed period of time or are conditioned upon the occurrence or non-occurrence of at least one prespecified action.

11. The method of claim 1, wherein exchanging assets for value comprises:
transferring one or more voting assets from an account associated with the seller to an account associated with the buyer, wherein both accounts are within the voting exchange platform; and
transferring economic value from the account associated with the buyer to the account associated with the seller.

12. The method of claim 1, further comprising:
presenting a user interface for the user to submit voting decisions to exercise voting rights corresponding to at least one voting asset for a corporate meeting, the at least one voting asset being held by an account associated with the user on the voting exchange platform.

13. The method of claim 12, further comprising:
retrieving one or more proposals to be voted upon in the corporate meeting;
presenting the proposals to a plurality of users of the voting exchange platform;
receiving one or more voting decisions from a subset of the plurality of users who own voting assets with voting rights pursuant to the corporate meeting; and
providing the voting decisions to an internal or external voting platform, election inspector, election tabulator, or other entity designated by the corporation.

14. The method of claim 13, further comprising:
upon completion of the associated corporate meeting, performing a vote audit to ensure that the voting decisions corresponding to each voting asset were cast in accordance with the voting decisions, if any, of the corresponding owner of such assets.

15. A communication system comprising one or more processors configured to perform the operations of: maintaining a voting exchange platform comprising a plurality of users, each associated
with an account; receiving a request from a user to issue one or more voting assets based on voting rights the user is entitled to act upon, the request comprising record information corresponding to the voting rights entitled to the user or pertaining to a corporate meeting associated with the voting rights; issuing voting assets corresponding to the voting rights pursuant to a shareholder meeting;
receiving a trading request corresponding to at least a subset of the issued voting assets via the voting exchange platform, wherein the trading request represents one of a purchase request or a sale request; matching the trading request with a complementary purchase request or sale request; and processing the matched requests by exchanging assets for value between a first account associated with a buyer and a second account associated with a seller on the voting exchange platform.

16. The communication system of claim 15, wherein the trading request is a sale request comprising one or more terms to be agreed upon by any future buyer of the voting assets.

17. The communication system of claim 16, wherein the stipulations comprise one or more of: an expiration date for the voting assets, one or more proposals associated with the voting assets, one or more rights obtained upon purchasing, whether the associated voting rights or associated proxy form are revocable or irrevocable, and restraining or allowing a buyer to resell the voting assets.

18. A non-transitory computer-readable medium containing instructions, comprising:
instructions for maintaining a voting exchange platform comprising a plurality of users, each associated with an account;
instructions for receiving a request from a user to issue one or more voting assets based on voting rights the user is entitled to act upon, the request comprising record information corresponding to the voting rights entitled to the user or pertaining to a corporate meeting associated with the voting rights;
instructions for issuing voting assets corresponding to the voting rights pursuant to a corporate meeting; instructions for receiving a trading request corresponding to at least a subset of the issued voting assets via the voting exchange platform, wherein the trading request represents one of a purchase request or a sale request;
instructions for matching the trading request with a complementary purchase request or sale request; and
instructions for processing the matched requests by exchanging assets for value between a first account associated with a buyer and a second account associated with a seller on the voting exchange platform.

19. The non-transitory computer-readable medium of claim 18, further comprising:
presenting an issuance form or proxy form to the voting rights owner or proxy thereof for requesting issuance of the voting assets backed by the voting or proxy rights, the issuance form or proxy form comprising a plurality of terms to be agreed upon by the voting rights owner or proxy thereof,
wherein receiving the request from the shareholder voting rights owner or proxy thereof to issue the voting assets comprises receiving a completed issuance form or proxy form.

20. The non-transitory computer-readable medium of claim 19, further comprising:
storing the completed issuance form or proxy form within a database;
receiving a request for the completed issuance form, proxy form, or an associated identifying document thereof from a requesting party comprising one of: the voting rights owner, a proxy thereof, or a purchaser of the issued voting assets; and
in response to the request, presenting the completed issuance form, proxy form, or associated identifying document thereof to the requesting party.

21. The non-transitory computer-readable medium of claim 18, wherein information from the trading request is communicated or displayed on the voting exchange platform to other entities or users.
